(19) United States
(12) Patent Application Publication
(10) Pub. No.: US 2026/0039865 A1
(43) Pub. Date: Feb. 5, 2026

(54) SEARCH REGION MODIFICATION FOR INTRA TEMPLATE MATCHING PREDICTION

(71) Applicant: BEIJING DAJIA INTERNET INFORMATION TECHNOLOGY CO., LTD., Beijing (CN)

(72) Inventors: Xiaoyu XIU, San Diego, CA (US); Hong-Jheng JHU, San Diego, CA (US); Changyue MA, San Diego, CA (US); Ning YAN, San Diego, CA (US); Che-Wei KUO, San Diego, CA (US); Wei CHEN, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 19/355,184

(22) Filed: Oct. 10, 2025

Related U.S. Application Data
(63) Continuation-in-part of application No. PCT/US2024/023677, filed on Apr. 9, 2024.
(63) Continuation-in-part of application No. PCT/US2024/024755, filed on Apr. 16, 2024.
(63) Continuation-in-part of application No. PCT/US2024/033023, filed on Jun. 7, 2024.
(60) Provisional application No. 63/458,419, filed on Apr. 10, 2023.
(60) Provisional application No. 63/459,967, filed on Apr. 17, 2023.
(60) Provisional application No. 63/471,924, filed on Jun. 8, 2023.

(51) Int. Cl. H04N 19/593; H04N 19/105; H04N 19/176; H04N 19/96

(52) U.S. Cl. CPC H04N 19/593; H04N 19/105; H04N 19/176; H04N 19/96

(57) ABSTRACT

Apparatuses, a method for video decoding, and a method for video encoding are provided. A search region is determined for a video block from the video frame. The search region includes a first region a first distance away from the video block in a first direction and a second distance away from the video block in a second direction perpendicular to the first direction, a second region adjacent the first region in the first direction and the second distance away from the video block in the second direction, and a third region adjacent the first region in the second direction and the first distance away from the video block in the first direction. A reference block is determined from the search region. A template of the reference block matches a template of the video block. Prediction samples are determined for the video block based on the reference block.

### CROSS-REFERENCE TO RELATED APPLICATIONS

This application is a continuation-in-part application of PCT Application No. PCT/US2024/023677 filed on Apr. 9, 2024, which is based upon and claims priority to U.S. Provisional Application No. 63/458,419 filed on Apr. 10, 2023. This application is also a continuation-in-part application of PCT Application No. PCT/US2024/024755 filed on Apr. 16, 2024, which is based upon and claims priority to U.S. Provisional Application No. 63/459,967 filed on Apr. 17, 2023. This application is also a continuation-in-part application of PCT Application No. PCT/US2024/033023 filed on Jun. 7, 2024, which is based upon and claims priority to U.S. Provisional Application No. 63/471,924 filed on Jun. 8, 2023. The entire contents of each above-identified application are incorporated herein by reference in their entirety.

### TECHNICAL FIELD

This application is related to video coding and compression. More specifically, this application relates to video processing apparatuses and methods for intra template matching prediction (TMP).

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### SUMMARY

Implementations of the present disclosure provide a method for video decoding. The method may include determining, by a processor, a search region for a video block from a video frame of a video. The search region includes a first region a first distance away from the video block in a first direction and a second distance away from the video block in a second direction perpendicular to the first direction, a second region adjacent the first region in the first direction and the second distance away from the video block in the second direction, and a third region adjacent the first region in the second direction and the first distance away from the video block in the first direction. The method may further include determining, by the processor, a reference block from the search region. A template of the reference block matches a template of the video block. The method may further include determining, by the processor, prediction samples for the video block based on the reference block.

Implementations of the present disclosure provide a method for video encoding. The method may include determining, by a processor, a search region for a video block from a video frame of a video. The search region includes a first region a first distance away from the video block in a first direction and a second distance away from the video block in a second direction perpendicular to the first direction, a second region adjacent the first region in the first direction and the second distance away from the video block in the second direction, and a third region adjacent the first region in the second direction and the first distance away from the video block in the first direction. The method may further include determining, by the processor, a reference block from the search region. A template of the reference block matches a template of the video block. The method may further include determining, by the processor, prediction samples for the video block based on the reference block.

Implementations of the present disclosure also provide an apparatus for video decoding. The apparatus may include a memory configured to store a bitstream and a processor coupled to the memory. The processor may be configured to perform a method for video decoding disclosed herein.

Implementations of the present disclosure also provide an apparatus for video encoding. The apparatus may include a memory configured to store a bitstream and a processor coupled to the memory. The processor may be configured to perform a method for video encoding disclosed herein.

Implementations of the present disclosure also provide a non-transitory computer-readable storage medium having stored therein a bitstream to be decoded by the method for video decoding disclosed herein.

Implementations of the present disclosure also provide a non-transitory computer-readable storage medium having stored therein a bitstream generated by the method for video encoding disclosed herein.

Implementations of the present disclosure also provide a method for storing a bitstream, comprising: performing the method for video encoding according to claim 17 to generate a bitstream; and storing the bitstream.

It is to be understood that both the foregoing general description and the following detailed description are examples only and are not restrictive of the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram illustrating an exemplary system for encoding and decoding video blocks in accordance with some implementations of the present disclosure.

FIG. 2 is a block diagram illustrating an exemplary video encoder in accordance with some implementations of the present disclosure.

FIG. 3 is a block diagram illustrating an exemplary video decoder in accordance with some implementations of the present disclosure.

FIGS. 4A through 4E are block diagrams illustrating how a frame is recursively partitioned into multiple video blocks of different sizes and shapes in accordance with some implementations of the present disclosure.

FIG. 5A is an illustration of a search region of an intra TMP mode in Enhanced Compression Model (ECM) in accordance with some examples.

FIG. 5B is a block diagram illustrating a reference block in a search region in accordance with some implementations of the present disclosure.

FIG. 6 is a flow chart of an exemplary method for intra TMP on a video frame of a video in accordance with some implementations of the present disclosure.

FIG. 7A is an illustration of a modified search region of an intra TMP mode in accordance with some implementations of the present disclosure.

FIG. 7B is another illustration of a modified search region of an intra TMP mode in accordance with some implementations of the present disclosure.

FIGS. 8A-8C illustrate methods of generating sample values for unreconstructed samples in accordance with some implementations of the present disclosure.

FIGS. 9A-9B illustrate performing an iterative search method on a search region with a scaling factor in accordance with some implementations of the present disclosure.

FIG. 10 illustrates examples of a spatial location of template samples of a template that are available to a video block in accordance with some implementations of the present disclosure.

FIG. 11 is a flow chart of another exemplary method 1000 for intra TMP on a video frame of a video in accordance with some implementations of the present disclosure.

FIG. 12 is a flow chart of another exemplary method 1100 for intra TMP on a video frame of a video in accordance with some implementations of the present disclosure.

FIG. 13 is a diagram illustrating a computing environment coupled with a user interface, according to some implementations of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with digital video capabilities.

It should be illustrated that the terms “first,” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

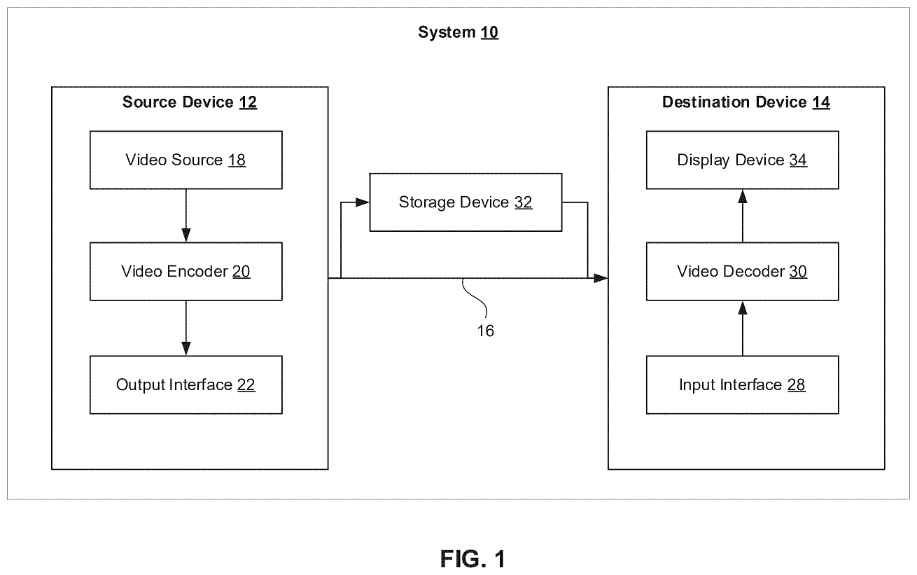

FIG. 1 is a block diagram illustrating an exemplary system 10 for encoding and decoding video blocks in parallel in accordance with some implementations of the present disclosure. As shown in FIG. 1, the system 10 includes a source device 12 that generates and encodes video data to be decoded at a later time by a destination device 14. The source device 12 and the destination device 14 may comprise any of a wide variety of electronic devices, including desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may comprise any type of communication medium or device capable of moving the encoded video data from the source device 12 to the destination device 14. In one example, the link 16 may comprise a communication medium to enable the source device 12 to transmit the encoded video data directly to the destination device 14 in real time. The encoded video data may be modulated according to a communication standard, such as a wireless communication protocol, and transmitted to the destination device 14. The communication medium may comprise any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may comprise any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

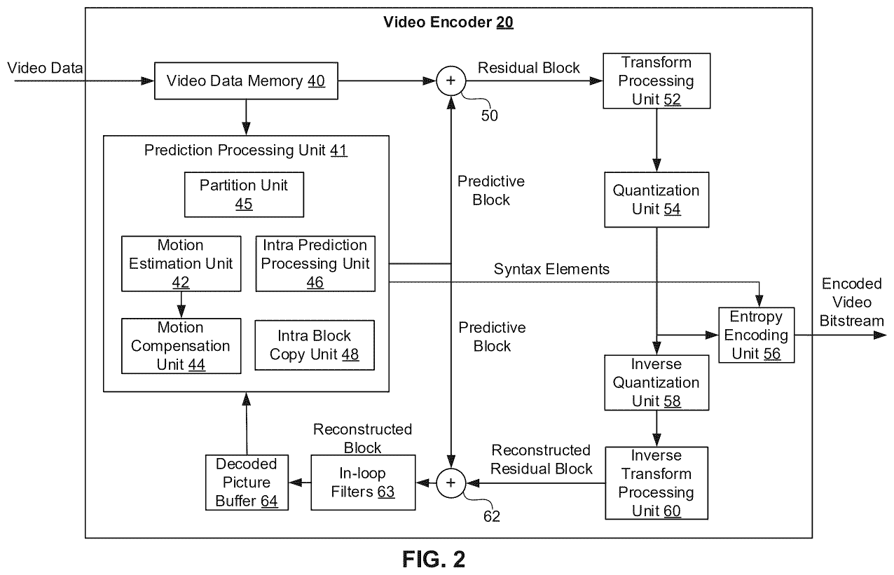

FIG. 2 is a block diagram illustrating an exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter, Cross Component Sample Adaptive Offset (CCSAO) filter and/or Adaptive in-Loop Filter (ALF), may also be used in addition to the deblocking filter to filter an output of the summer 62. It should be illustrated that for the CCSAO technique, the present application is not limited to the embodiments described herein, and instead, the application may be applied to a situation where an offset is selected for any of a luma component, a Cb chroma component and a Cr chroma component according to any other of the luma component, the Cb chroma component and the Cr chroma component to modify said any component based on the selected offset. Further, it should also be illustrated that a first component mentioned herein may be any of the luma component, the Cb chroma component and the Cr chroma component, a second component mentioned herein may be any other of the luma component, the Cb chroma component and the Cr chroma component, and a third component mentioned herein may be a remaining one of the luma component, the Cb chroma component and the Cr chroma component. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g. a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1, or archived in the storage device 32 as shown in FIG. 1 for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

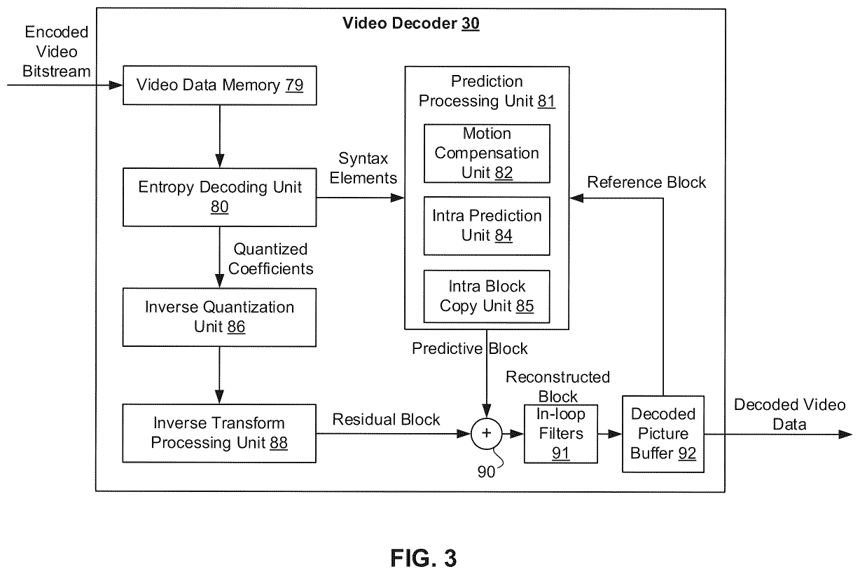

FIG. 3 is a block diagram illustrating an exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purposes, the video data memory 79 and the DPB 92 are depicted as two distinct components of the video decoder 30 in FIG. 3. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter, CCSAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

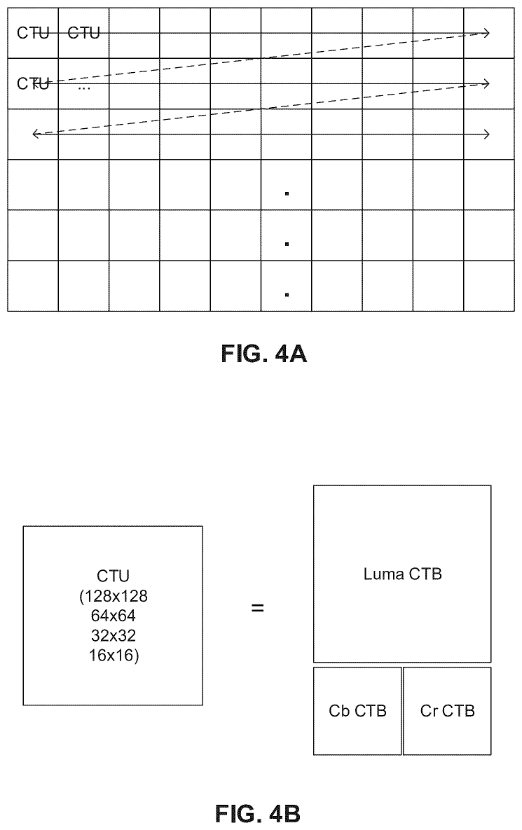

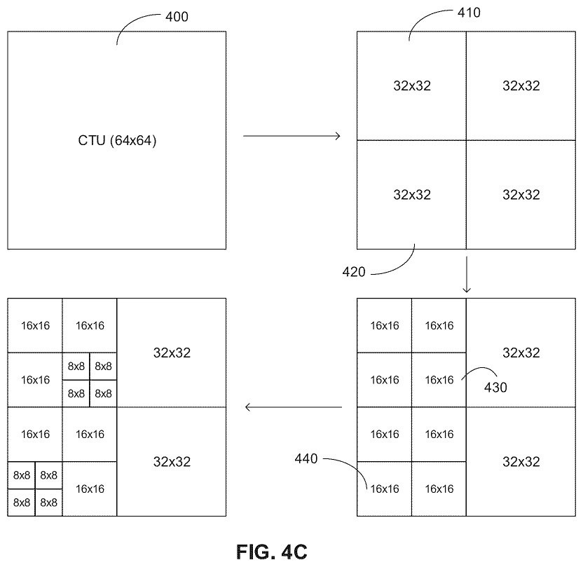

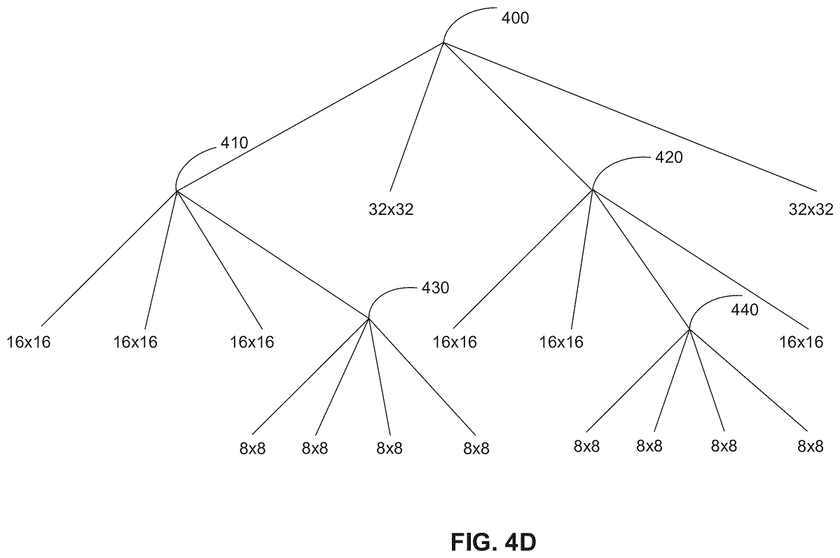

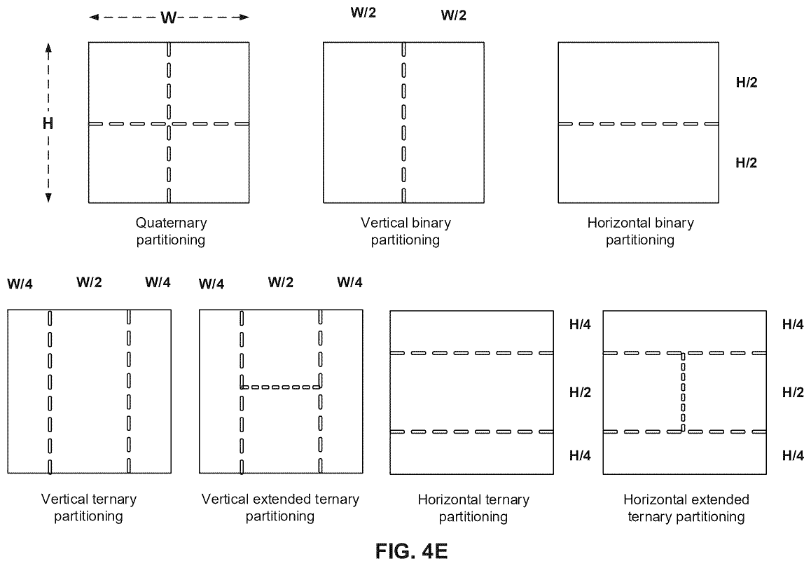

As shown in FIG. 4A, the video encoder 20 (or more specifically the partition unit 45) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 4B, each CTU may comprise one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may comprise a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may comprise a CB of luma samples and two corresponding coding blocks of chroma samples of a frame of the same size, and syntax elements used to code the samples of the coding blocks. In monochrome pictures or pictures having three separate color planes, a CU may comprise a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are seven possible partitioning types of a coding block having a width W and a height H, i.e., quaternary partitioning, horizontal binary partitioning, vertical binary partitioning, horizontal ternary partitioning, vertical ternary partitioning, horizontal extended ternary partitioning and vertical extended ternary partitioning.

In some implementations, the video encoder 20 may further partition a coding block of a CU into one or more M×N PBs. A PB is a rectangular (square or non-square) block of samples on which the same prediction, inter or intra, is applied. A PU of a CU may comprise a PB of luma samples, two corresponding PBs of chroma samples, and syntax elements used to predict the PBs. In monochrome pictures or pictures having three separate color planes, a PU may comprise a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may comprise a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever-improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit 42 as described above in connection with FIG. 2, the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

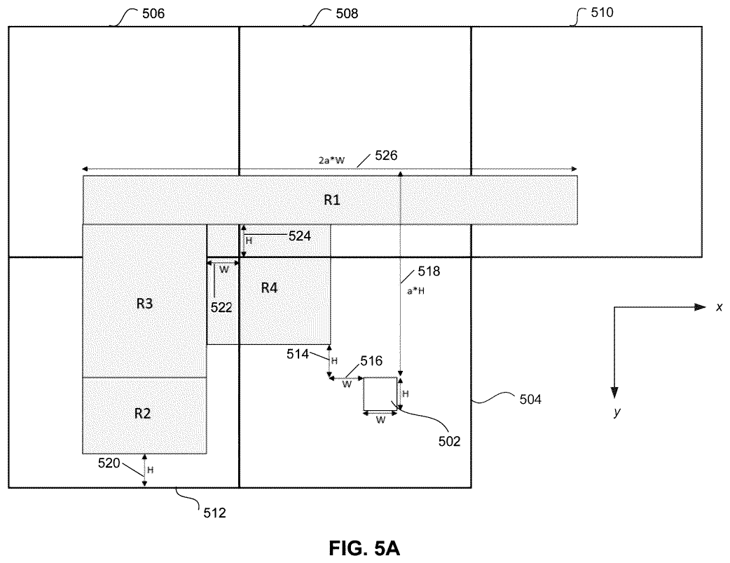

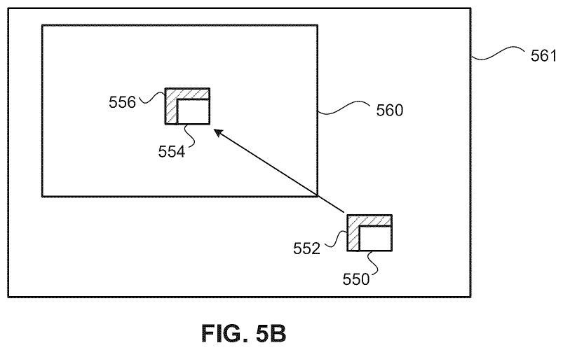

In the ECM, intra TMP can be utilized to improve the compression efficiency of intra coding. Intra TMP can be an intra prediction mode that generates prediction samples (or predictive samples) of a video block from a reference block in a reconstructed part of a current frame, where a template of the reference block matches a template of the video block. According to an intra TMP design, the template of the video block can have an L shape and include causal neighboring samples of the video block in the L shape. Similarly, a template of the reference block can also have an L shape and include causal neighboring samples of the reference block in the L shape. Example templates are illustrated below with reference to FIG. 5B. For a predefined search range, video encoder 20 may search for a reference block having a template most similar to the current template of the video block in the reconstructed part of the current video frame, and may use the reference block having the most similar template as a prediction block. The prediction block may include prediction samples of the video block. Video encoder 20 may then signal the usage of this intra TMP mode. Subsequently, similar prediction operations may be performed at the decoder side to generate the prediction block at the decoder side.

FIG. 5A illustrates an example search region of the intra TMP mode which delimits the area of the coordinate of the top-left corner of each candidate block (e.g., each potential reference block). A video block 502 is shown in FIG. 5A, which is part of a CTU 504. For example, video block 502 can be a coding block. The search region of FIG. 5A may include four regions (e.g., R1, R2, R3, and R4), where each region contains coordinates of top-left corners of candidate blocks. For example, for a top region R1, a set of coordinates (x, y) of a top-left corner of a candidate block in the top region R1 can be determined as follows:

$$currX - SearchRange\_w <= x <= currX + SearchRange\_w \qquad ( 1 )$$

$$currY - SearchRange\_h <= y <= ctuY - 1 - H \qquad ( 2 )$$

In the above expressions (1) and (2), currX and currY represent horizontal and vertical coordinates of the current video block 502 (e.g., a current coding block), respectively; W and H represent a width and a height of video block 502, respectively; and ctuY represents a vertical coordinate of CTU 504 that video block 502 belongs to. For example, (currX, currY) can be coordinates of a top-left corner of video block 502.

The dimensions of search ranges (SearchRange_w, SearchRange_h) can be set proportional to the block dimension (W, H). For example, SearchRange_w and SearchRange_h can be configured as follows:

$$SearchRange\_w = a * W \qquad ( 3 )$$

$$SearchRange\_h = a * H \qquad ( 4 )$$

In the above expressions (3) and (4), “a” can be a constant that controls the trade-off between the gain and the complexity. In one implementation, “a” can be equal to 5.

For example, for a bottom-left region R2, a set of coordinates (x, y) of a top-left corner of a candidate block in the bottom-left region R2 can be determined as follows:

$$currX - SearchRange\_w <= x <= currX - 1 - W \qquad ( 5 )$$

$$currY + 1 <= y <= ctuY + ctuH - 1 - H \qquad ( 6 )$$

In the above expression (6), ctuH represents a height of CTU 504.

For example, for a left region R3, a set of coordinates (x, y) of a top-left corner of a candidate block in the left region R3 can be determined as follows:

$$currX - SearchRange\_w <= x <= ctuX - 1 - W \qquad ( 7 )$$

$$ctuY - 1 - H <= y <= currY \qquad ( 8 )$$

In the above expressions (7) and (8), ctuX and ctuY represent a horizontal coordinate and a vertical coordinate of CTU 504, respectively. For example, (ctuX, ctuY) can be coordinates of a top-left corner of CTU 504.

For example, for a top-left region R4, a set of coordinates (x, y) of a top-left corner of a candidate block in the top-left region R4 can be determined as follows:

$$ctuX - W <= x <= currX - W \qquad ( 9 )$$

$$ctuY - H <= y <= currY - H \qquad ( 10 )$$

With reference to FIG. 5A, three CTUs 506, 508, and 510 may be above CTU 504. For example, CTU 508 may be on top of and adjacent to CTU 504. CTU 506 may be on the left of and adjacent to CTU 508. CTU 510 may be on the right of and adjacent to CTU 508. An additional CTU 512 may be on the left of and adjacent to CTU 504. CTUs 506, 508, 510, 512, and 504 are in the same video frame.

The top region R1 may include a first portion in CTU 506, a second portion in CTU 508, and a third portion in CTU 510. A width 526 of the top region R1 in a horizontal direction (e.g., the x direction) can be 2a*W. A distance 518 between a top boundary of the top region R1 and video block 502 in a vertical direction (e.g., the y direction) can be a*H. A distance 524 between the top region R1 and CTU 504 in the vertical direction can be H.

The left region R3 may be below and adjacent to the top region R1, and may include a first portion in CTU 506 and a second portion in CTU 512. A distance 522 between the left region R3 and CTU 504 in the horizontal direction can be W.

The bottom-left region R2 may be in CTU 512. The bottom-left region R2 may be below and adjacent to the left region R3. A distance 520 between a bottom boundary of the bottom-left region R2 and a bottom boundary of CTU 512 in the vertical direction can be H. The bottom-left region R2 may have the same width as the left region R3 in the horizontal direction.

The top-left region R4 may include a first portion in CTU 506, a second portion in CTU 508, a third portion in CTU 512, and a fourth portion in CTU 504. The top-left region R4 may be blow and adjacent to the top region R1, and may be on the right of and adjacent to the left region R3. The top-left region R4 may be away from video block 502 by a distance 516 of W in the horizontal direction and away from video block 502 by a distance 514 of H in the vertical direction.

In some implementations, a difference metric such as SAD can be used as a cost function to identify the reference block in the search region. For example, within the search region, video encoder 20 or video decoder 30 may search for a template that has the least SAD with respect to the template of the video block, and may select a candidate block corresponding to the template having the least SAD as a prediction block.

In some implementations, the intra TMP can be enabled for CUs with a size less than or equal to 64 in width and height. It is contemplated that the maximum CU size for intra TMP can be configurable. In some implementations, the intra TMP mode can be signaled at the CU level through an indication flag.

It is contemplated that terms, such as “top,” “bottom,” “left,” “right,” “upper,” “lower,” “above,” “below,” etc., are used for purpose of describing the relative positions of regions in a particular coordinate system, as illustrated in FIG. 5A and additional figures below. They are not intended to limit the particular locations or orientations of the regions. For example, a first region described as at the top-left of a second region in the illustrated coordinate system, may be viewed as positioned at one distance relative to the second region in a vertical direction and at another distance relative to the second region in a horizontal direction in the coordinate system.

FIG. 5B is a block diagram illustrating a reference block 554 in a search region 560 in accordance with some implementations of the present disclosure. A template 556 of reference block 554 may match a template 552 of a video block 550 in the same video frame 561. Each of template 556 and template 552 has an L shape. Reference block 554 can be determined to be a prediction block for video block 550. For example, when compared to templates of other candidate blocks in search region 560, template 556 of reference block 554 may have the least SAD with respect to template 552 of video block 550. Then, prediction samples in the prediction block can be generated based on reference block 554. For example, samples of reference block 554 can be treated as prediction samples in the prediction block.

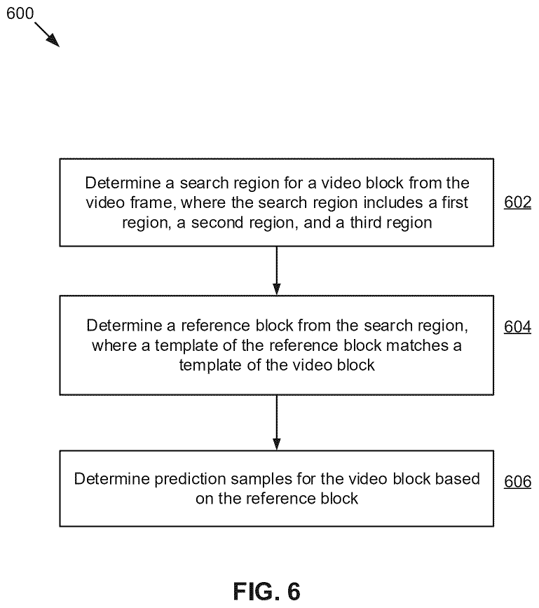

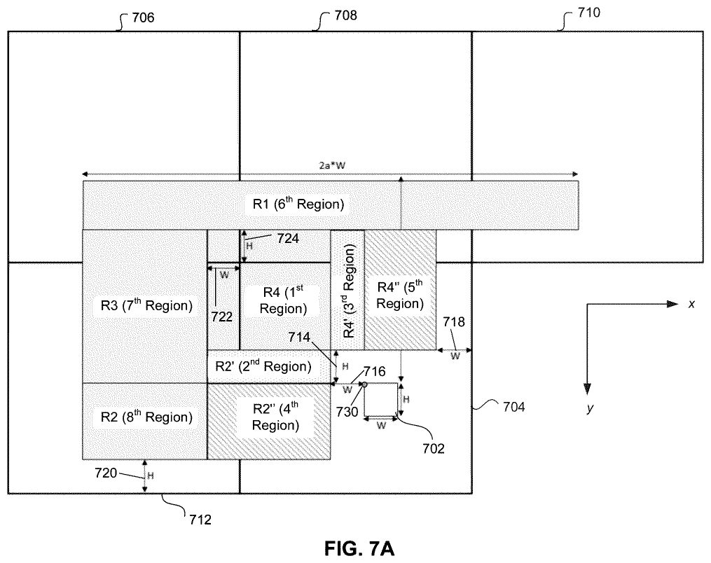

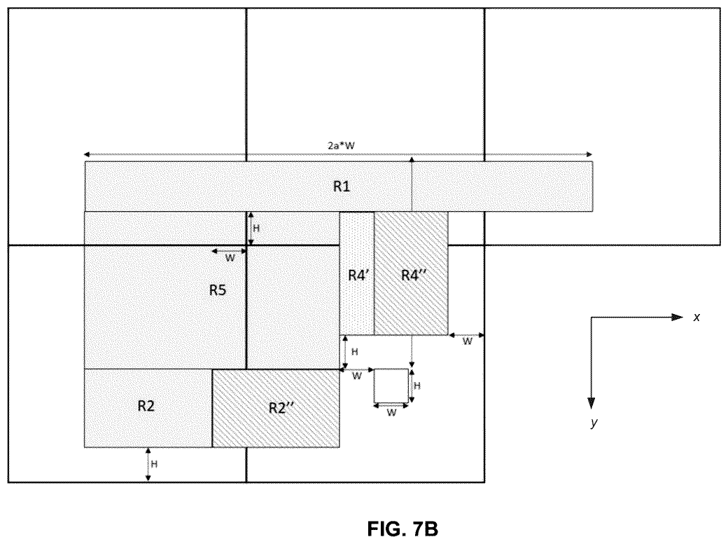

Consistent with some implementations of the present disclosure, an improved intra TMP scheme is disclosed herein to provide significant improvement of intra coding efficiency of the ECM. For example, the improved intra TMP scheme disclosed herein may include methods and apparatus to improve and simplify the coding efficiency of an intra TMP tool by modifying a search region of reconstructed samples in the same video frame for the synthesis of a coding block. As discussed with reference to FIG. 5A, the search region of the intra TMP mode may include reconstructed samples in four different regions R1, R2, R3, and R4. Within the search region, the four regions R1, R2, R3 and R4 may include all the available reconstructed samples from the top CTU row (e.g., blocks 506, 508, 510) and the left CTU (e.g., block 512), but not all the available reconstructed samples in the same CTU (e.g., block 504) of the current coding block (e.g., video block 502). However, in statistics, candidate blocks whose locations are closer to the current coding block should be more correlated with the coding block, i.e., providing better intra prediction efficiency. Based on such consideration, the improved TMP scheme disclosed herein extends the search region shown in FIG. 5A to include more available reconstructed samples within the current CTU as described below with reference to FIGS. 6 and 7A-7B.

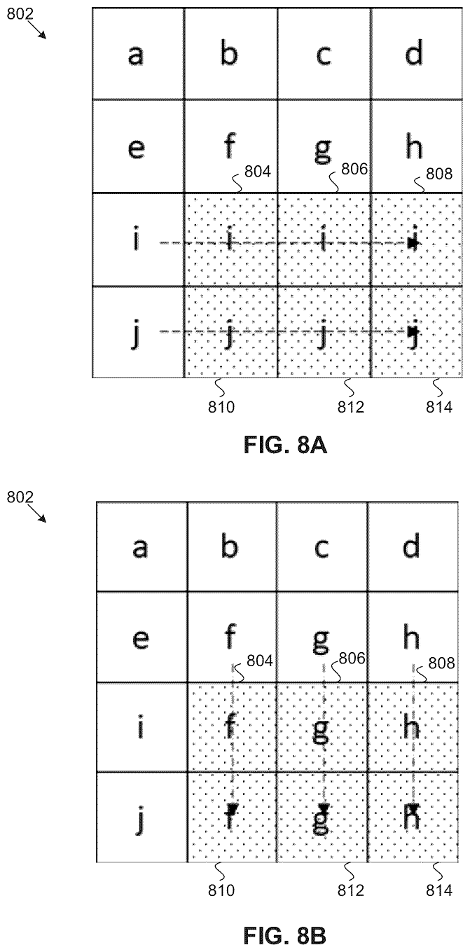

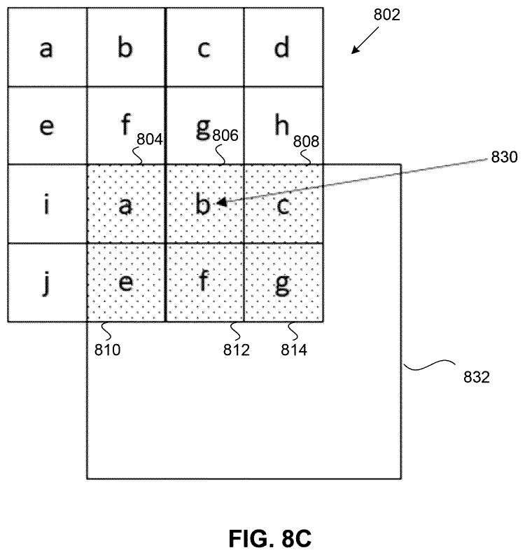

FIG. 6 is a flow chart of an exemplary method 600 for intra TMP on a video frame of a video in accordance with some implementations of the present disclosure. Method 600 may be implemented by a processor associated with video encoder 20 or video decoder 30, and may include steps 602-606 as described below. Some of the steps may be optional to perform the disclosure provided herein. Further, some of the steps may be performed simultaneously, or in a different order than shown in FIG. 6. FIG. 7A is an illustration of a modified search region of an intra TMP mode in accordance with some implementations of the present disclosure. FIG. 7B is another illustration of a modified search region of an intra TMP mode in accordance with some implementations of the present disclosure. FIGS. 8A-8C illustrate methods of generating sample values for unreconstructed samples in accordance with some implementations of the present disclosure. FIGS. 6, 7A-7B, and 8A-8C are described below together.

In step 602, as illustrated in FIG. 6, the processor may determine a search region for a video block from the video frame. With reference to FIG. 7A, the video frame may include CTUs 706, 708, 710, 712, and 704, where a video block 702 is included in the current CTU 704. A search region may include a first region (a top-left region R4) which is a first distance 714 away from video block 702 in a first direction (e.g., the vertical direction) and a second distance 716 away from video block 702 in a second direction (e.g., the horizontal direction) perpendicular to the first direction. First distance 714 in the first direction can be equal to a height of video block 702 in the first direction. Second distance 716 in the second direction can be equal to a width of video block 702 in the second direction. The first region R4 in FIG. 7A may be like the top-left region R4 of FIG. 5A, and the similar description will not be repeated herein.

The search region may also include a second region (a secondary left region R2′) adjacent the first region R4 in the first direction and the second distance 716 away from the video block in the second direction. The second region R2′ may have a same width as the first region R4 in the second direction. A height of the second region R2′ can be equal to the height of video block 702 in the first direction. The search region may also include a third region (a secondary top-left region R4′) adjacent the first region R4 in the second direction and the first distance 714 away from the video block in the first direction. The third region R4′ may have a same height as the first region R4 in the first direction. A width of the third region R4′ is equal to the width of video block 702 in the second direction.

For example, the improved intra TMP scheme disclosed herein can further include additional reconstructed samples (which are located on the top-left of the current video block 702) into the search region of the intra TMP mode. These additional top-left reconstructed samples are located on the right of the first region R4 or below the first region R4. Specifically, as shown in FIG. 7A, two new regions R2′ and R4′ can be included in the search region. For the second region R2′, a set of coordinates (x, y) of a top-left corner of a candidate block within the second region R2′ can be determined as follows:

$$ctuX - W <= x <= currX - W \qquad ( 11 )$$

$$currY - H + 1 <= y <= currY \qquad ( 12 )$$

For the third region R4′, a set of coordinates (x, y) of a top-left corner of a candidate block within the third region R4′ can be determined as follows:

$$currX - W + 1 <= x <= currX \qquad ( 13 )$$

$$ctuY - H <= y <= currY - H \qquad ( 14 )$$

With reference to FIG. 7A, the search region may further include a fourth region (e.g., a secondary bottom-left region R2″) adjacent the second region R2′ in the first direction and the second distance 716 away from the video block in the second direction. The fourth region R2″ may have the same width as the first region R4 and the second region R2′. The search region may further include a fifth region (e.g., a top-right region R4″) adjacent the third region R4′ in the second direction and the first distance 714 away from the video block in the first direction. The fifth region R4″ may have the same height as the first region R4 and the third region R4′ in the first direction. A third distance 718 between the fifth region R4″ and a right boundary of CTU 704 in the second direction is equal to the width of video block 702. A fourth distance 720 between the fourth region R2″ and a bottom boundary of CTU 704 in the first direction is equal to the height of video block 702. The fourth region R2″ is the second distance 716 away from video block 702 in the second direction. The fifth region R4″ is the first distance 714 away from video block 702 in the first direction.

For example, due to a binary-tree or ternary-tree based partition structure, in addition to the samples that are located on top of or on the left of video block 702, some samples that are located in the top-right or bottom-left positions relative to video block 702 can also be available (e.g., reconstructed) before the encoding/decoding of video block 702. Therefore, in order to further improve the intra TMP performance, the improved intra TMP scheme disclosed herein can further include reconstructed samples that are located on top-right or bottom-left positions relative to video block 702 into the search region of the intra TMP mode. Specifically, as shown in FIG. 7A, two additional regions R2″ and R4″ are included in the search region. For the fourth region R2″, a set of coordinates (x, y) of a top-left corner of a candidate block within the fourth region R2″ can be determined as follows:

$$ctuX - W <= x <= currX - W \qquad ( 15 )$$

$$currY + 1 <= y <= ctuY + ctuH - 1 - H \qquad ( 16 )$$

For the fifth region R4″, a set of coordinates (x, y) of a top-left corner of a candidate block within the fifth region R4″ can be determined as follows:

$$currX + 1 <= x <= ctuX + ctuW - 1 - W \qquad ( 17 )$$

$$ctuY - H <= y <= currY - H \qquad ( 18 )$$

In the above expressions (16) and (17), ctuW and ctuH represent a width and a height of CTU 704, respectively.

In some examples, the fourth region R2″ and the fifth region R4″ can be determined based at least in part on a picture size of the video frame and a template size of the template of video block 702 (or a template size of a reference block related to video block 702). The template size may include a template width in the second direction (e.g., the horizontal direction) and a template height in the first direction (e.g., the vertical direction). The picture size may include a picture width in the second direction and a picture height in the first direction. A left boundary of the fourth region R2″ can be determined based at least in part on the template width, and a bottom boundary of the fourth region R2″ can be determined based at least in part on the picture height. A right boundary of the fifth region R4″ can be determined based at least in part on the picture width, and an upper boundary of the fifth region R4″ can be determined based at least in part on the template height.

For example, for the fourth region R2″, a set of coordinates (x, y) of a top-left corner of a candidate block within the fourth region R2″ can be determined as follows:

$$max ( templateWidth , ctuX - W ) <= x <= currX - W \qquad ( 19 a )$$

$$currY + 1 <= y <= min ( pic Height - H , ctuY + ctuH - 1 - H ) \qquad ( 20 a )$$

For example, for the fifth region R4″, a set of coordinates (x, y) of a top-left corner of a candidate block within the fifth region R4″ can be determined as follows:

$$currX + 1 <= x <= min ( pic Width - W , ctuX - 1 - W ) \qquad ( 21 a )$$

$$max ( templateHeight , ctuY - H ) <= y <= currY - H \qquad ( 22 a )$$

In the above expressions (19a), (20a), (21a), and (22a), picWidth and picHeight represent the picture width and the picture height, respectively; and templateWidth and templateHeight represent the template width and the template height, respectively.

In some examples, when encoding or decoding a video block on a left picture (or slice) boundary, there are only top neighboring reconstructed samples available (i.e., only top template samples being available). In some other examples, for a video block on a top picture (or slice) boundary, there are only left neighboring reconstructed samples available (i.e., only left template samples being available) when encoding or decoding the video block. In either examples, one or more regions may be determined for the video block based at least in part on a spatial location of template samples of the template that are available to the video block. The spatial location of the template samples in the template that are available to the video block may indicate a template type of the template of the video block.

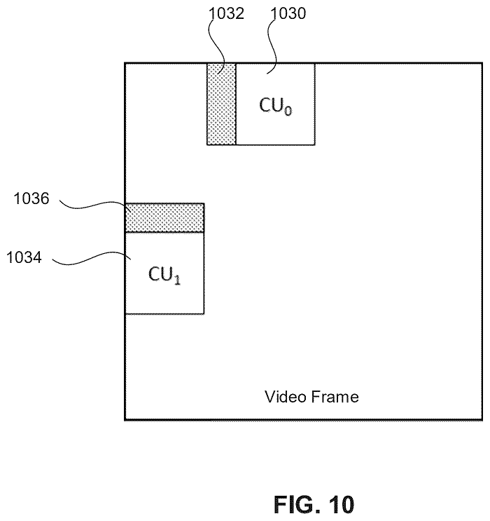

Referring to FIG. 10, examples of a spatial location of template samples of a template that are available to a video block are illustrated. The spatial location of the template samples available to the video block may depend on a spatial location of the video block in the video frame. In some implementations, the template samples are available only in the first direction when the video block is on a first boundary of the video frame in the second direction. For example, the template samples are available only in the vertical direction (e.g., on top of the video block) when the video block is on the left boundary of the video frame in the horizontal direction. In a further example as illustrated in FIG. 10, for a video block 1034 (CU₁) on the left picture boundary (the left boundary of the video frame), only template samples 1036 on top of video block 1034 (e.g., top template samples) are available in a template of video block 1034. In this case, a template type of the template of video block 1034 may be referred to as an above-template-only type (e.g., tempType=ABOVE_TEMPLATE_ONLY).

Alternatively, the template samples are available only in the second direction when the video block is on a second boundary of the video frame in the first direction. For example, the template samples are available only in the horizontal direction (e.g., on the left of the video block) when the video block is on the top boundary of the video frame in the vertical direction. In a further example as illustrated in FIG. 10, for a video block 1030 (CU₀) on the top picture boundary (the top boundary of the video frame), only template samples 1032 on the left of video block 1030 (e.g., left template samples) are available in a template of video block 1030. In this case, a template type of the template of video block 1030 may be referred to as a left-template-only type (e.g., tempType=LEFT_TEMPLATE_ONLY).

Then, intra TMP regions for the video block with only one set of template samples (e.g., only a set of left template samples or only a set of top template samples) can be determined based on a spatial location of the template samples that are available to the video block. In a first example, responsive to the template samples being only available in the first direction, a second dimension (e.g., a horizontal dimension) of the fourth region R2″ in the second direction can extend to the left boundary of the video frame. That is, for a video block associated with an “ABOVE_TEMPLATE_ONLY” template type, because there are no template samples on the left of the video block that can be used for the intra TMP search, a horizontal dimension of the fourth region R2″ can extend to the left boundary of the video frame, instead of the templateWidth's column of the video frame as shown in the above expression (19a). For example, with respect to the fourth region R2″, a set of coordinates (x, y) of a top-left corner of a candidate block within the fourth region R2″ can be determined as follows:

$$max ( ( temp Type == ABOVE\_TEMPLATE \_ONLY ? 0 : templateWidth ) , ctuX - W ) <= x <= currX - W \qquad ( 19 B )$$

$$currY + 1 <= y <= min ( pic Height - H , ctuY + ctuH - 1 - H ) \qquad ( 20 b )$$

In the above expression (19b), tempType indicates a template type of the template of the video block; and “tempType==ABOVE_TEMPALTE_ONLY? 0: templateWidth” indicates a ternary conditional operator, which is equal to 0 when the condition “tempType==ABOVE_TEMPALTE_ONLY” is true (when the template type is the ABOVE_TEMPALTE_ONLY type), or equal to templateWidth when the condition “temp Type==ABOVE_TEMPALTE_ONLY” is false (when the template type is not the ABOVE_TEMPALTE_ONLY type).

In a second example, responsive to the template samples being only available in the second direction, a first dimension (e.g., a vertical dimension) of the fifth region R4″ in the first direction can extend to the top boundary of the video frame in the first direction. That is, for a video block associated with a LEFT_TEMPLATE_ONLY template type, because there are no template samples above the video block that can be used for the intra TMP search, a vertical dimension of the fifth region R4″ can extend to the top boundary of the video frame, instead of the templateHeight's row of the video frame as shown in the above expression (22a). For example, with respect to the fifth region R4″, a set of coordinates (x, y) of a top-left corner of a candidate block within the fifth region R4″ can be determined as follows:

$$currX + 1 <= x <= min ( pic Width - W , ctuX + ctuW - 1 - W ) \qquad ( 21 b )$$

$$max ( ( temp Type == LEFT\_TEMPLATE \_ONLY ? 0 : templateHeight ) , ctuY - H ) <= y <= currY - H \qquad ( 22 b )$$

In the above expression (22b), “tempType==LEFT_TEMPALTE_ONLY? 0: templateWidth” indicates a ternary conditional operator, which is equal to 0 when the condition “tempType==LEFT_TEMPALTE_ONLY” is true (when the template type is the LEFT_TEMPALTE_ONLY type), or equal to templateHeight when the condition “tempType==LEFT_TEMPALTE_ONLY” is false (when the template type is not the LEFT_TEMPALTE_ONLY_type).

Based on the above expressions (19b), (20b), (21b), and (22b), the fourth region R2″ and the fifth region R4″ can be determined based at least in part on the spatial location of the template samples available to the video block, a template size of the template of the video block, and the picture size of the video frame. For example, a boundary (e.g., the left boundary) of the fourth region R2″ in the second direction is determined based at least in part on the spatial location of the template samples available to the video block (e.g., indicated by the template type) and the template width, as shown in the expression (19b). Another boundary (e.g., the bottom boundary) of the fourth region R2″ in the first direction is determined based at least in part on the picture height, as shown in the expression (20b). In another example, a boundary (the right boundary) of the fifth region R4″ in the second direction is determined based at least in part on the picture width, as shown in the expression (21b). Another boundary (e.g., the top boundary) of the fifth region R4″ in the first direction is determined based at least in part on the spatial location of the template samples available to the video block (e.g., indicated by the template type) and the template height, as shown in the expression (22b).

In some examples, in order to control the total number of candidate blocks to be searched, the width of the fourth region R2″ and the width of the fifth region R4″ can be constrained. The constrained fourth region R2″ can be determined as follows:

$$max ( ctuX - W , currX - searchRange ) <= x <= currX - W \qquad ( 19 c )$$

$$currY + 1 <= y <= ctuY + ctuH - 1 - H \qquad ( 20 c )$$

The constrained fifth region R4″ can be determined as follows:

$$currX + 1 <= x <= ctuX + min ( ctuX + ctuW - 1 - W , searchRange ) \qquad ( 21 c )$$

$$ctuY - H <= y <= currY - H \qquad ( 22 c )$$

In the above expressions (19c) and (21c), searchRange can be the maximum horizontal region size of R2″ and R4″. For example, a value of searchRange can be determined to be proportional to the width of video block 702, i.e., searchRange=m*W, where m represents a numeric coefficient.

With further reference to FIG. 7A, the search region may further include a sixth region R1 (a top region R1), a seventh region R3 (e.g., a left region R3), and an eighth region R2 (a bottom left region R2). The sixth region R1 may be adjacent to the first region, the third region, and the fifth region in the vertical direction. A fifth distance between an upper boundary of the sixth region R1 and video block 702 in the vertical direction is equal to a product of the height of the video block and the constant a (e.g., a*H). A sixth distance 724 between the sixth region R1 and CTU 704 in the vertical direction is equal to the height of the video block (e.g., H).

The seventh region R3 may be adjacent to the sixth region R1 in the vertical direction and adjacent to the first region R4 and the second region R2′ in the horizontal direction. A height of the seventh region R3 is equal to a sum of a height of the first region R4 and a height of the second region R2′. A distance 722 between the seventh region R3 and CTU 704 in the horizontal direction is equal to the width of the video block (e.g., W).

The eighth region R2 may be adjacent to the seventh region R3 in the vertical direction and adjacent to the fourth region R2″ in the horizontal direction. A height of the eighth region R2 is equal to a height of the fourth region R2″, and a width of the eighth region R2 is equal to a width of the seventh region R3. A fourth distance 720 between the eighth region R2 and a bottom-boundary of CTU 712 in the vertical direction is equal to the height of the video block (e.g., H).

The sixth region R1, the seventh region R3, and the eighth region R2 may be like the top region R1, the left region R3, and the bottom-left region R2 of FIG. 5A, respectively, and the similar description will not be repeated herein. In some implementations, the first region R4, the second region R2′, and the seventh region R3 can be merged into a single region R5, as shown in FIG. 7B.

Consistent with some implementations of the present disclosure, the search region has a first search-region dimension in the first direction and a second search-region dimension in the second direction. A constraint may be applied to all the regions (e.g., R1, R2, R3, R4, R2′, R4, R2″, and R4″) included in the search region, such that each of the regions is within an area determined by the first search-region dimension, the second search-region dimension, and a location of video block 702 in the video frame. In some specific implementations, a location of video block 702 can be at a top-left corner sample position 730 of video block 702. A center of the area can be located at top-left corner sample position 730 of video block 702. In some implementations, a height of the area can be twice of the first search-region dimension in the first direction, and a width of the area can be twice of the second search-region dimension in the second direction.

For example, for each of the regions (e.g., R1, R2, R3, R4, R2′, R4, R2″, and R4″), a set of coordinates (x, y) of a top-left corner of a candidate block within the region can be determined as follows:

$$currX - searchRange X <= x <= currX - searchRange X \qquad ( 23 )$$

$$currY - searchRange Y <= y <= curry + searchRange Y \qquad ( 24 )$$

In the above expressions (23) and (24), searchRangeX and searchRangeY represent the second search-region dimension (e.g., a horizontal search-region dimension) and the first search-region dimension (e.g., a vertical search-region dimension), respectively. In some implementations, the first search-region dimension and the second search-region dimension may be proportional to the height H and the width W of video block 702, respectively. For example, searchRangeX=m*W, and searchRangeY=n*H (e.g., m and n can be set to 5; or, m and n can be set to any other suitable values).

In some examples, a search region constraint and a template-type dependent search constraint can be applied jointly. For example, the fourth region R2″ and the fifth region R4″ can be determined based at least in part on the spatial location of the template samples available to the video block (e.g., indicated by the template type), the first search-region dimension, and the second search-region dimension. In another example, the fourth region R2″ and the fifth region R4″ can be determined based on the spatial location of the template samples available to the video block, the first search-region dimension, the second search-region dimension, a template size of the template of the video block, and a picture size of the video frame, as shown below in expressions (25)-(28).

In some implementations, a boundary (e.g., the left boundary) of the fourth region R2″ in the second direction is determined based at least in part on the spatial location of the template samples available to the video block (e.g., the template type), the template width, and the second search-region dimension (e.g., searchRangeX). Another boundary (e.g., the bottom boundary) of the fourth region R2″ in the first direction is determined based at least in part on the picture height and the first search-region dimension (e.g., searchRangeY). For instance, with respect to the fourth region R2″, a set of coordinates (x, y) of a top-left corner of a candidate block within the fourth region R2″ can be determined as follows:

$$max ( max ( ( temp Type == ABOVE\_TEMPLATE \_ONLY ? 0 : templateWidth ) , ctuX - W ) , currX - searchRange X ) <= x <= min ( currX - W , currX + searchRange X ) \qquad ( 25 )$$

$$max ( currY + 1 , currY - searchRange Y ) <= y <= min ( min ( pic Height - H , ctuY + ctuH - 1 - H ) , currY + searchRange Y ) \qquad ( 26 )$$

In some implementations, a boundary (e.g., the right boundary) of the fifth region R4″ in the second direction is determined based at least in part on the second search-region dimension and the picture width. Another boundary (e.g., the top boundary) of the fifth region R4″ in the first direction is determined based at least in part on the spatial location of the template samples available to the video block (e.g., the template type), the template height, and the first search-region dimension. For instance, with respect to the fifth region R4″, a set of coordinates (x, y) of a top-left corner of a candidate block within the fifth region R4″ can be determined as follows:

$$max ( currX + 1 , currX - searchRange X ) <= x <= min ( min ( pic Width - W , ctuW - 1 - W ) , currX + searchRangeX ) \qquad ( 27 )$$

$$max ( max ( ( temp Type == LEFT\_TEMPLATE \_ONLY ? 0 : templateWidth ) , ctuY - H ) , currY - searchRangeY ) <= y <= min ( currY - H , currY + searchRangeY ) \qquad ( 28 )$$

With respect to the second region R2′ and the third region R4′, all the samples that are included in the regions R2′ and R4′ are located top-left relative to video block 702 and are reconstructed before the encoding/decoding of video block 702, which is similar to that of the regions R1, R2, R3, and R4. Therefore, when candidate blocks are obtained from the regions R2′ and R4′, there is no need to perform an availability check on the candidate blocks. The availability check is described below in more detail.

With respect to the fourth region R2″ and the fifth region R4″, samples in the regions R2″ and R4″ may be obtained from search areas that are below or right to video block 702, which may not be reconstructed before the encoding/decoding of video block 702 is started. For example, both reconstructed samples and unreconstructed samples are included in the fourth region R2″ and the fifth region R4″. Correspondingly, when candidate blocks are obtained from the regions R2″ and R4″, the availability check may be conducted to decide whether all the samples in the corresponding candidate blocks are already reconstructed or not, as described below in more detail.

Referring back to FIG. 6, in step 604, the processor may determine a reference block from the search region, where a template of the reference block matches a template of the video block. Specifically, the processor may determine a plurality of candidate blocks from the search region, and determine a plurality of templates for the plurality of candidate blocks, respectively. The processor may determine, from the plurality of templates, a template that matches the template of the video block, and determine the reference block to be a first candidate block having the template that matches the template of the video block.

In some implementations, the processor may determine that the plurality of candidate blocks may include one or more second candidate blocks from the fourth region R2″ or the fifth region R4″. The one or more second candidate blocks from the fourth region R2″ or the fifth region R4″ may include unreconstructed samples. For each second candidate block, the processor may perform an availability check on the second candidate block.

In some instances, for each second candidate block, the processor may determine whether the second candidate block includes at least an unreconstructed sample. Responsive to determining that the second candidate block includes at least an unreconstructed sample, the processor may determine that the second candidate block fails the availability check. Or, responsive to determining that the second candidate block includes no unreconstructed samples, the processor may determine that the second candidate block passes the availability check.

In some instances, for each second candidate block, the processor may determine whether a sample at a bottom-right corner of the second candidate block is reconstructed or not. Responsive to the sample at the bottom-right corner of the second candidate block is unreconstructed, the processor may determine that the second candidate block fails the availability check. Or, responsive to the sample at the bottom-right corner of the second candidate block is reconstructed, the processor may determine that the second candidate block passes the availability check.

Responsive to determining that the second candidate block passes the availability check, the processor may keep the second candidate block in the plurality of candidate blocks. Or, responsive to determining that the second candidate block fails the availability check, the processor may remove the second candidate block from the plurality of candidate blocks. For example, if all the samples in a candidate block from the fourth region R2″ or the fifth region R4″ are reconstructed (i.e., available), the candidate block is deemed as a valid intra TMP candidate block to predict the video block. Otherwise (i.e., at least one sample in the candidate block is not reconstructed yet), the candidate block is not allowed to be referenced in the prediction of the video block.

In another example, assuming that all candidate blocks have a rectangular shape and the coding order (based on the corresponding partition structure) of the video block in one picture/slice is from top to bottom and from left to right. When checking the availability of a candidate block from the fourth region R2″ or the fifth region R4″, the processor only needs to check the availability of the coordinate of the bottom-right corner of the candidate block to determine whether all the samples in the candidate block are reconstructed or not. Specifically, when the bottom-right sample of the candidate block is already reconstructed, it can guarantee that all the samples in the candidate block are available. Otherwise, when the bottom-right sample of the candidate block is not yet reconstructed, there is at least one sample in the candidate block which is not available to be referenced yet (i.e., the candidate block is not ready to be used as an intra TMP candidate block).

In the above examples, a candidate block in the regions R2″ and R4″ is allowed to be used as an intra TMP candidate block only if all the samples inside the candidate block are already reconstructed before the encoding/decoding of the video block. Such constraint may reduce the total number of valid intra TMP candidate blocks from which the video block can be predicted and therefore limit the overall coding performance of the intra TMP mode. To address this issue, the improved TMP scheme disclosed herein may further generate sample values for the unreconstructed samples (e.g., unavailable samples) from its neighboring available samples of the candidate block such that the candidate block can become a valid candidate block for the intra TMP mode.

Specifically, responsive to determining that the second candidate block from the fourth region R2″ or the fifth region R4″ fails the availability check, the processor may determine unreconstructed samples in the second candidate block. The processor may update the second candidate block by generating sample values for the unreconstructed samples, so that the updated second candidate block can be kept in the plurality of candidate blocks. In some implementations, the sample values for the unreconstructed samples can be generated using at least one of a horizontal repetitive padding method, a vertical repetitive padding method, an adaptive repetitive method, or a collocated copying method, as described below in more detail.

For example, the horizontal repetitive padding method can be applied to generate sample values for unreconstructed samples in a candidate block from the region R2″ or the region R4″. Specifically, a sample value of each unreconstructed sample (each unavailable sample) in the candidate block can be generated by directly copying a sample value of the nearest reconstructed sample (the nearest available sample) in the horizontal direction. For example, as shown in FIG. 8A, a candidate block 802 from the region R2″ or the region R4″ may include reconstructed samples (e.g., available samples) a, b, c, d, e, f, g, h, i, and j. Candidate block 802 may also include unreconstructed samples (e.g., unavailable samples) 804, 806, 808, 810, 812, and 814 (labeled with a shaded area in FIG. 8A). For unreconstructed samples 804, 806, and 808 in a row, the nearest reconstructed sample in the horizontal direction is the reconstructed sample i. Thus, a sample value of each unreconstructed sample 804, 806, and 808 can be generated by directly copying a sample value of the nearest reconstructed sample i in the horizontal direction. For unreconstructed samples 810, 812, and 814 in another row, the nearest reconstructed sample in the horizontal direction is the reconstructed sample j. Thus, a sample value of each unreconstructed sample 810, 812, and 814 can be generated by directly copying a sample value of the nearest reconstructed sample j in the horizontal direction.

In another example, the vertical repetitive padding method can be applied to generate sample values for unreconstructed samples in a candidate block from the region R2″ or the region R4″. Specifically, a sample value of each unreconstructed sample in the candidate block can be generated by directly copying a sample value of the nearest reconstructed sample in the vertical direction. For example, as shown in FIG. 8B, for unreconstructed samples 804 and 810 in a column of candidate block 802, the nearest reconstructed sample in the vertical direction is the reconstructed sample f. Thus, a sample value of each unreconstructed sample 804 and 810 can be generated by directly copying a sample value of the nearest reconstructed sample f in the vertical direction. For unreconstructed samples 806 and 812 in another column of candidate block 802, the nearest reconstructed sample in the vertical direction is the reconstructed sample g. Thus, a sample value of each unreconstructed sample 806 and 812 can be generated by directly copying a sample value of the nearest reconstructed sample g in the vertical direction. For unreconstructed samples 808 and 814 in yet another column of candidate block 802, the nearest reconstructed sample in the vertical direction is the reconstructed sample h. Thus, a sample value of each unreconstructed sample 808 and 814 can be generated by directly copying a sample value of the nearest reconstructed sample h in the vertical direction.

In yet another example, the adaptive repetitive padding method may be applied where the unreconstructed samples can be generated by copying either a sample value of the nearest reconstructed sample in the horizontal direction (e.g., horizontal padding) or a sample value of the nearest reconstructed sample in the vertical direction (e.g., vertical padding) in the same candidate block. The decision on whether to select the horizontal padding or the vertical padding can be decided based on different methods. For example, a gradient filter (e.g., Sober filter) can be applied to calculate the gradients of the already reconstructed samples inside the candidate block. If a majority of the gradients (e.g., more than 50%, 60%, or 70%, etc., of the gradients) are close to be horizontal, the horizontal repetitive padding method may be applied. Otherwise (when a majority of the gradients are close to be vertical), the vertical repetitive padding method may be applied.

In still yet another example, when a candidate block from the region R2″ or the region R4″ is partially overlapped with the video block, the collocated copying method can be applied, where unreconstructed samples in an overlapped region between the candidate block and the video block are directly copied from the collocated samples in the candidate block. The collocated samples in the candidate block may have the same sample positions in the candidate block as the unreconstructed samples in the video block. For example, as illustrated in FIG. 8C, candidate block 802 and a video block 832 may have an overlapped region 830 (a shaded area in FIG. 8C), which may include six unreconstructed samples 804, 806, 808, 810, 812, and 814. That is, six sample positions at the bottom-right portion of candidate block 802 are overlapped with six sample positions at the top-left portion of video block 832. In other words, the six bottom-right samples in candidate block 802 are located at the 6 top-left sample positions in video block 832. Correspondingly, the 6 unreconstructed bottom-right samples (804, 806, 808, 810, 812, 814) are generated by directly copying the 6 top-left samples (a, b, c, e, f, g) of candidate block 802.

Consistent with some implementations of the present disclosure, different orders may be applied to scan reconstructed samples in different regions to identify the best intra TMP candidate block which may lead to various performance and complexity trade-off. The best intra TMP candidate block may be a candidate block having a template matching the template of the video block. For example, a scan order may be determined for the regions (e.g., R1, R2, R3, R4, R2′, R4′, R2″, R4″ illustrated in FIG. 7A; or R1, R5, R2, R2″, R4′, R4″ illustrated in FIG. 7B), such that the best intra TMP candidate block can be searched for in the regions according to the scan order. Generally speaking, the samples in a region that is closer to the video block are more correlated with the samples in the video block, and therefore can be scanned earlier. Based on such consideration, in a first example, the regions R1, R2, R3, R4, R2′, R4′, R2″, and R4″ illustrated in FIG. 7A can be scanned based on the order of R4″->R4′->R1->R3->R4->R2′->R2″->R2. In a second example, when the regions R3, R4, and R2′ are merged into the region R5 as illustrated in FIG. 7B, the corresponding order to scan the regions R1, R2, R5, R2″, R4′, and R4″ becomes R4″->R4′->R1->R5->R2″->R2.

In some implementations, different scan order combinations can be applied to the six regions R4′, R4″, R2″, R1, R2, and R5 illustrated in FIG. 7B. For example, the following scan order can be applied: R4′->R2″->R4″->R1->R5->R2. In another example, the scan order of R4′->R4″->R2″->R1->R5->R2 can be applied. In yet another example, the scan order of R4″->R4′->R2″->R1->R5->R2 can be applied. In still yet another example, the scan order of R4″->R2″->R4′->R1->R5->R2 can be applied. In still yet another example, the scan order of R2″->R4″->R4′->R1->R5->R2 can be applied. In still yet another example, the scan order of R2″->R4′->R4″->R1->R5->R2 can be applied. In still yet another example, the scan order of R4′->R1->R5->R2->R2″->R4″ can be applied.

Consistent with some implementations of the present disclosure, the processor may perform an iterative search method on the search region with at least a scaling factor to identify a candidate block having a template which matches the template of the video block. The candidate block having the template matching the template of the video block (also referred to as the best intra TMP candidate block) is determined as the reference block for the video block. That is, to further reduce the complexity, the iterative search method can be applied to iteratively identify the best intra TMP candidate block.

Specifically, in a first step of the iterative search method, a region can be subsampled by a scaling factor scale to find one or more initial intra TMP candidate blocks. Then, around each initial intra TMP candidate block, a local refinement can be conducted with a gradually reduced search step to look for a refined intra TMP candidate block. In each round of the local refinement, the current search step is reduced to be half of the previous search step. For example, in a first round of the local refinement, the search step can be reduced to be scale/2, while in a second round of the local refinement, the search step can be reduced to be scale/4, so on and so forth. In another example, in a first round of the local refinement, the search step can be reduced to be floor (scale/2) of the previous search step (e.g., the current search step=floor (scale/2)× the previous search step), while in a second round of the local refinement, the search step can be reduced to be floor (scale/4) of the previous search step (e.g., the current search step=floor (scale/4)×the previous search step), so on and so forth, where floor(⋅) is a floor function. Such refinement can be continuously performed until the search step is reduced to be smaller than 1 or the refined intra TMP candidate block does not change in the refinement process.

Additionally, during the search process, a termination criterion may be applied to terminate the whole search process across all the regions or the search process in a specific region when a termination condition is satisfied. For instance, a distortion value of the refined intra TMP candidate block that is obtained during the search process so far can be used to determine the termination criterion. Specifically, when the distortion value is smaller than a predefined threshold, it is determined that the refined intra TMP candidate block is already good enough such that the search process can stop. Otherwise (i.e., the distortion value is equal to or larger than the predefined threshold), it is determined that the current refined intra TMP candidate needs to be further improved and thus the search process continues. In some implementations, the above termination scheme can be used for jumping out (or terminating) the whole search process across all the regions. Alternatively, the above termination scheme can be used independently for each region. For example, when the termination condition is met (e.g., when the distortion value is smaller than the predefined threshold), the search process on the samples in the current region can be terminated while the searching on the samples in the following regions may continue to be performed.

In some examples, an adaptive refinement scheme may be applied in the search process, where different subsampling scaling factors may be applied to different regions. For example, a region that is closer to the video block can be more correlated with the video block and can be searched with a smaller scaling factor, while another region that is farther away from the video block can be less correlated with the video block can be searched with a larger scaling factor. In a further example, a scaling factor of 2 (scale=2) can be used for the regions R4″ and R2″, and a scaling factor of 3 (scale=3) can be used for other regions. In another further example, a scaling factor of 2 (scale=2) can be used for all the regions.

Consistent with some implementations of the present disclosure, video encoder 20 may identify an optimal region from the search region, generate a bitstream to include an index of the optimal region, and transmit the bitstream to video decoder 30. Then, video decoder 30 may receive the bitstream including the index of the optimal region, and identify the optimal region from the search region based on the index. Video decoder 30 may determine the reference block from the optimal region.

For example, the complexity of the intra TMP mode is proportional to the number of candidate blocks that are checked to identify the best intra TMP candidate block. To reduce the intra TMP complexity, an explicit region-based intra TMP mode can be used. For example, the total search region of the intra TMP mode is divided into multiple regions, e.g., the regions R4″, R4′, R1, R5, R2″, and R2 as illustrated in FIG. 7B, such that each region can provide an independent intra TMP candidate (i.e., a candidate block with the smallest distortion metric within the region). At the encoder side, the multiple regions can be tested through rate-distortion-optimization (RDO) and the best region (the optimal region) is identified with an index of the region. The index of the optimal region can be transmitted to video decoder 30 in a bitstream. At the decoder side, after receiving the index of the optimal region, the intra TMP search process only needs to be carried out in a region corresponding to the index of the optimal region.

Referring back to FIG. 6, in step 606, the processor may determine prediction samples for the video block based on the reference block. For example, prediction samples in a prediction block may be the same as corresponding samples in the reference block. In some implementations, a bitstream may be generated to include encoded data associated with a difference between the video block and the prediction block, as described above with reference to FIG. 2. In some implementations, the bitstream may also include an indication indicating that an intra prediction mode is the intra TMP.

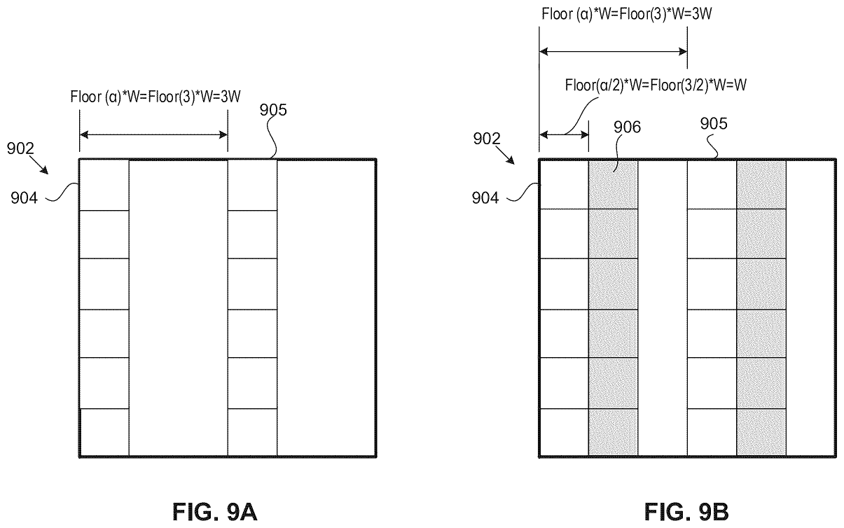

FIGS. 9A-9B illustrate performing an iterative search method on a search region with a scaling factor in accordance with some implementations of the present disclosure. Referring to FIG. 9A, taking a horizontal search as one example, a region 902 can be initially subsampled by a scaling factor α to find one or more initial candidate blocks. For example, assuming α=3, an initial search step can be equal to floor(3)*W=3 W, where W is a width of a video block, and floor(⋅) is a floor function. Then, around each initial candidate block, a local refinement can be conducted with a gradually reduced search step to look for a refined candidate block. For example, in a first round of the local refinement with respect to first initial candidate block 904, the search step can be reduced to be floor(α/2)*W=floor (3/2)*W=W, such that a refined candidate block 906 can be found, as shown in FIG. 9B. After the first round of the local refinement with respect to first initial candidate block 904, the search step is reduced to be floor (α/4)*W=floor(3/4)*W=0. Since the search step becomes smaller than 1, the local refinement around first initial candidate block 904 can be terminated.

Similar operations can be performed for other initial candidate blocks until the search process in region 902 terminates. For example, if a termination condition is satisfied (e.g., a distortion value of the refined candidate block that is obtained during the search process so far is smaller than a predefined threshold), it is determined that the refined candidate block is already good enough such that the search process can stop. Otherwise (i.e., the distortion value is equal to or larger than the predefined threshold), it is determined that the current refined candidate block needs to be further improved and thus the search process continues. If the whole region 902 has been searched, the search process may continue to be performed in other regions until the termination condition is satisfied.

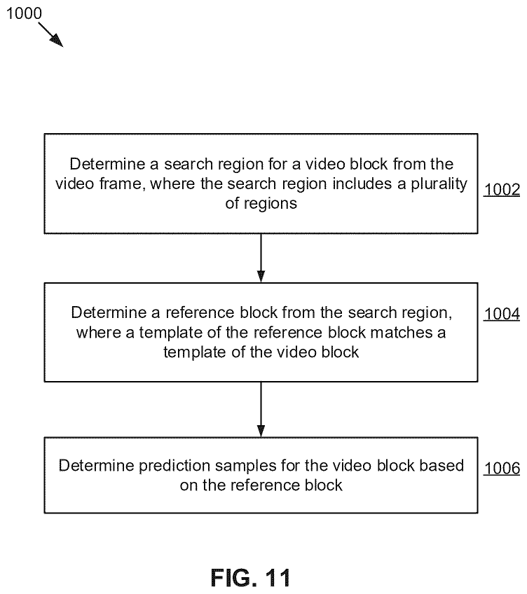

FIG. 11 is a flow chart of another exemplary method 1000 for intra TMP on a video frame of a video in accordance with some implementations of the present disclosure. Method 1000 may be implemented by a processor associated with video encoder 20 or video decoder 30, and may include steps 1002-1006 as described below. Some of the steps may be optional to perform the disclosure provided herein. Further, some of the steps may be performed simultaneously, or in a different order than shown in FIG. 11.

In step 1002, as illustrated in FIG. 11, the processor may determine a search region for a video block from the video frame. The search region may have a first search-region dimension in the first direction (e.g., a vertical search-region dimension in the vertical direction) and a second search-region dimension in the second direction (e.g., a horizontal search-region dimension in the horizontal direction). The search region may include a plurality of regions, each within an area determined by the first search-region dimension, the second search-region dimension, and a location of the video block in the video frame. For example, each of the regions can be determined based on the expressions (23) and (24) described above.

In some implementations, a center of the area can be located at the location of the video block. For example, the location of the video block can be at a top-left corner sample position of the video block. A height of the area can be twice of the first search-region dimension in the first direction, and a width of the area can be twice of the second search-region dimension in the second direction. The first search-region dimension and the second search-region dimension may be proportional to a height and a width of the video block, respectively.

In some implementations, the plurality of regions may include at least one of the following: the first region R4 at a first distance away from the video block in the first direction and at a second distance away from the video block in the second direction; the second region R2′ adjacent the first region R4 in the first direction and at the second distance away from the video block in the second direction; the third region R4′ adjacent the first region R4 in the second direction and at the first distance away from the video block in the first direction; the fourth region R2″ adjacent the second region R2′ in the first direction and at the second distance away from the video block in the second direction; or the fifth region R4″ adjacent the third region R4′ in the second direction and at the first distance away from the video block in the first direction.

In some implementations, the fourth region R2″ and the fifth region R4″ may be determined based at least in part on a template size of the template of the video block (or a template size of a reference block corresponding to the video block) and a picture size of the video frame. The template size may include a template width in the second direction and a template height in the first direction. The picture size may include a picture width in the second direction and a picture height in the first direction. A left boundary of the fourth region R2″ can be determined based at least in part on the template width, and a bottom boundary of the fourth region R2″ can be determined based at least in part on the picture height. A right boundary of the fifth region R4″ can be determined based at least in part on the picture width, and an upper boundary of the fifth region R4″ can be determined based at least in part on the template height.

In some implementations, the video frame is divided into a plurality of CTUs, and the video block is located within one of the CTUs. The search region further includes at least one of the following: the sixth region R1 adjacent the first region R4, the third region R4′, and the fifth region R4″ in the first direction, where a distance between an upper boundary of the sixth region R1 and the video block in the first direction is equal to a product of the height of the video block and a constant “a” as described above, and a distance between the sixth region R1 and the one of the CTUs in the first direction is equal to the height of the video block; the seventh region R3 adjacent the sixth region R1 in the first direction and adjacent the first region R4 and the second region R2′ in the second direction, where a distance between the seventh region R3 and the one of the CTUs in the second direction is equal to the width of the video block; or the eighth region R2 adjacent the seventh region R3 in the first direction and adjacent the fourth region R2″ in the second direction, where a distance between the eighth region R2 and the one of the CTUs in the second direction is equal to the width of the video block.

In step 1004, the processor may determine a reference block from the search region. A template of the reference block matches a template of the video block. For example, operations like those described above with reference to step 604 of FIG. 6 can be performed in step 1004, and the similar descriptions will not be repeated herein.

In some implementations, the processor may determine a scan order for the plurality of regions, and search the plurality of regions for the reference block based on the scan order.

In step 1006, the processor may determine prediction samples for the video block based on the reference block. For example, operations like those described above with reference to step 606 of FIG. 6 can be performed in step 1006, and the similar descriptions will not be repeated herein.

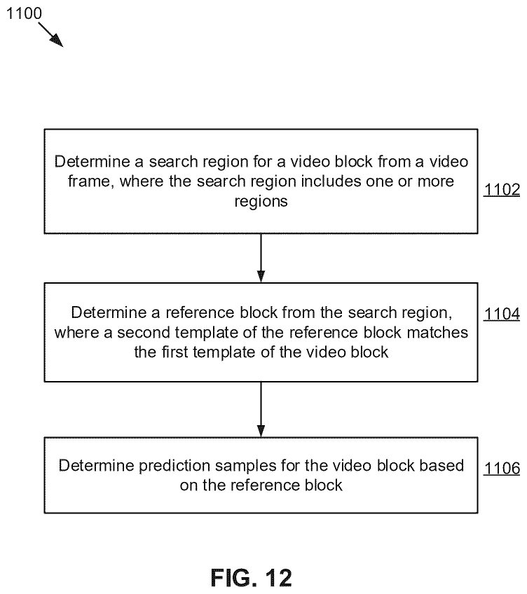

FIG. 12 is a flow chart of another exemplary method 1100 for intra TMP on a video frame of a video in accordance with some implementations of the present disclosure. Method 1100 may be implemented by a processor associated with video encoder 20 or video decoder 30, and may include steps 1102-1106 as described below. Some of the steps may be optional to perform the disclosure provided herein. Further, some of the steps may be performed simultaneously, or in a different order than shown in FIG. 12.

In step 1102, as illustrated in FIG. 12, the processor may determine a search region for a video block from the video frame. The search region may include one or more regions determined based at least in part on a spatial location of template samples of a first template of the video block that are available to the video block.

In some implementations, the spatial location of the template samples available to the video block depends on a spatial location of the video block in the video frame.

In some implementations, the template samples are available only in a first direction when the video block is on a first boundary of the video frame in a second direction perpendicular to the first direction; or, the template samples are available only in the second direction when the video block is on a second boundary of the video frame in first second direction. In one implementation, the first direction may be a horizontal direction and the second direction may be a vertical direction. In an alternative implementation, the first direction may be a vertical direction and the second direction may be a horizontal direction. For example, when the video block is on a left boundary of the video frame, the template samples are available only on top of the video block (e.g., as shown by video block 1034 and template samples 1036 of FIG. 10 described above). In another example, when the video block is on a top boundary of the video frame, the template samples are available only on the left of the video block (e.g., as shown by video block 1030 and template samples 1032 of FIG. 10 described above).

In some implementations, the search region includes at least one of the following: a first region R4 with a first distance away from the video block in the first direction and with a second distance away from the video block in the second direction perpendicular to the first direction; a second region R2′ adjacent to the first region R4 in the first direction and with the second distance away from the video block in the second direction; a third region R4′ adjacent to the first region R4 in the second direction and with the first distance away from the video block in the first direction; a fourth region R2″ adjacent to the second region R2′ in the first direction and with the second distance away from the video block in the second direction; or a fifth region R4″ adjacent to the third region R4′ in the second direction and with the first distance away from the video block in the first direction. The one or more regions include at least one of the fourth region R2″ or the fifth region R4″.

In some implementations, determining the search region includes: responsive to the template samples being only available in the second direction, determining that a first dimension of the fifth region R4″ in the first direction extends to the second boundary of the video frame. For example, for a video block associated with a LEFT_TEMPLATE_ONLY template type (e.g., the template samples only available on the left of the video block), because there are no template samples above the video block that can be used for intra TMP search, a vertical dimension of the fifth region R4″ can extend to the top boundary of the video frame.

In some implementations, determining the search region includes: responsive to the template samples being only available in the first direction, determining that a second dimension of the fourth region R2″ in the second direction extends to the first boundary of the video frame. For example, for a video block associated with an “ABOVE_TEMPLATE_ONLY” template type (e.g., the template samples only available on top of the video block), because there are no template samples on the left of the video block that can be used for the intra TMP search, a horizontal dimension of the fourth region R2″ can extend to the left boundary of the video frame.

In some implementations, the fourth region R2″ and the fifth region R4″ are determined based at least in part on the spatial location of the template samples available to the video block, a template size of the first template of the video block, and a picture size of the video frame.

In some implementations, the template size includes a template width in the second direction and a template height in the first direction; the picture size includes a picture width in the second direction and a picture height in the first direction; a boundary of the fourth region R2″ in the second direction is determined based at least in part on the spatial location of the template samples available to the video block and the template width, and another boundary of the fourth region R2″ in the first direction is determined based at least in part on the picture height; and a boundary of the fifth region R4″ in the second direction is determined based at least in part on the picture width, and another boundary of the fifth region R4″ in the first direction is determined based at least in part on the spatial location of the template samples available to the video block and the template height.

In some implementations, the search region has a first search-region dimension in the first direction and a second search-region dimension in the second direction; and the fourth region R2″ and the fifth region R4″ are determined based at least in part on the spatial location of the template samples available to the video block, the first search-region dimension, and the second search-region dimension. The spatial location of the template samples may be a location of those template samples relative to the video block (e.g., the template samples located only on the left or only on top of the video block, as described above with reference to FIG. 10).

In some implementations, the first search-region dimension and the second search-region dimension are proportional to a height and a width of the video block, respectively.

In some implementations, the fourth region R2″ and the fifth region R4″ are determined further based on a template size of the first template of the video block and a picture size of the video frame.

In some implementations, the template size comprises a template width in the second direction and a template height in the first direction; the picture size comprises a picture width in the second direction and a picture height. In some implementations, in the first directional boundary of the fourth region R2″ in the second direction is determined based at least in part on the spatial location of the template samples available to the video block, the template width, and the second search-region dimension; another boundary of the fourth region R2″ in the first direction is determined based at least in part on the picture height and the first search-region dimension; a boundary of the fifth region R4″ in the second direction is determined based at least in part on the second search-region dimension and the picture width; and another boundary of the fifth region R4″ in the first direction is determined based at least in part on the spatial location of the template samples available to the video block, the template height, and the first search-region dimension.

For example, as described above with reference to the expressions (25)-(26), a left boundary of the fourth region R2″ in the horizonal direction is determined based at least in part on the spatial location of the template samples available to the video block (e.g., the template type), the template width, and the horizontal search-region dimension (e.g., searchRangeX). A bottom boundary of the fourth region R2″ in the vertical direction is determined based at least in part on the picture height and the vertical search-region dimension (e.g., searchRangeY). In another example, as described above with reference to the expressions (27)-(28), a right boundary of the fifth region R4″ in the horizontal direction is determined based at least in part on the horizontal search-region dimension (e.g., searchRangeX) and the picture width. A top boundary of the fifth region R4″ in the vertical direction is determined based at least in part on the spatial location of the template samples available to the video block (e.g., the template type), the template height, and the vertical search-region dimension (e.g., searchRangeY).

In some implementations, the search region further includes at least one of the following: a sixth region R1 adjacent to the first region R4, the third region R4′, and the fifth region R4″ in the first direction; a seventh region R3 adjacent to the sixth region R1 in the first direction and adjacent to the first region R4 and the second region R2′ in the second direction; or an eighth region R2 adjacent to the seventh region R3 in the first direction and adjacent to the fourth region R2″ in the second direction.

In step 1104, the processor may determine a reference block from the search region. A second template of the reference block matches the first template. For example, operations like those described above with reference to step 604 of FIG. 6 can be performed in step 1104, and the similar descriptions will not be repeated herein.

In some implementations, determining the reference block from the search region includes: determining a plurality of candidate blocks from the search region; determining a plurality of templates for the plurality of candidate blocks, respectively; determining, from the plurality of templates, the second template that matches the first template of the video block; and determining the reference block to be a first candidate block having the second template that matches the first template of the video block. For example, when compared to other templates of other candidate blocks, the second template of the reference block may have a minimal difference metric (e.g., the least SAD, or the least SSD) with respect to the first template of the video block. Then, it can be considered that the second template of the reference block matches the first template of the video block.

In some implementations, method 1100 further includes determining that the plurality of candidate blocks include a second candidate block from the fourth region R2″ or the fifth region R4″; and performing an availability check on the second candidate block.

In some implementations, performing the availability check on the second candidate block includes: responsive to determining that the second candidate block includes at least an unreconstructed sample, determining that the second candidate block fails the availability check; or, responsive to determining that the second candidate block includes no unreconstructed samples, determining that the second candidate block passes the availability check.

In some implementations, performing the availability check on the second candidate block includes: responsive to a sample at a bottom-right corner of the second candidate block is unreconstructed, determining that the second candidate block fails the availability check; or, responsive to the sample at the bottom-right corner of the second candidate block is reconstructed, determining that the second candidate block passes the availability check.

In some implementations, method 1100 further includes: responsive to determining that the second candidate block passes the availability check, keeping the second candidate block in the plurality of candidate blocks as a valid candidate block; or, responsive to determining that the second candidate block fails the availability check, removing the second candidate block from the plurality of candidate blocks as an invalid candidate block.

In some implementations, method 1100 further includes: responsive to determining that the second candidate block fails the availability check, determining unreconstructed samples in the second candidate block, and updating the second candidate block by generating sample values for the unreconstructed samples so that the second candidate block becomes a valid candidate block.

In some implementations, the sample values for the unreconstructed samples are generated using at least one of a horizontal repetitive padding method, a vertical repetitive padding method, an adaptive repetitive padding method, or a collocated copying method.

In step 1106, the processor may determine prediction samples for the video block based on the reference block. For example, operations like those described above with reference to step 606 of FIG. 6 can be performed in step 1006, and the similar descriptions will not be repeated herein.

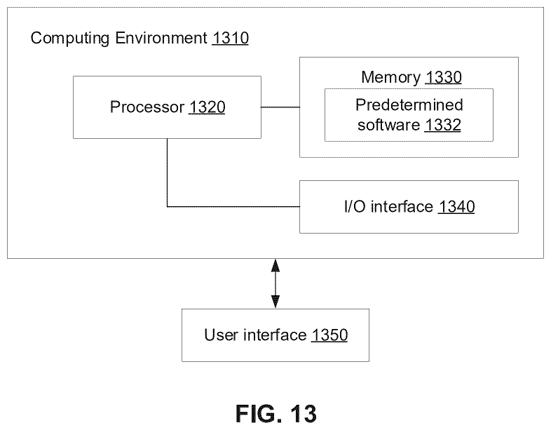

FIG. 13 shows a computing environment 1310 coupled with a user interface 1350. The computing environment 1310 can be part of a data processing server. The computing environment 1310 includes a processor 1320, a memory 1330, and an Input/Output (I/O) interface 1340.

The processor 1320 typically controls overall operations of the computing environment 1310, such as the operations associated with display, data acquisition, data communications, and image processing. The processor 1320 may include one or more processors to execute instructions to perform all or some of the steps in the above-described methods. Moreover, the processor 1320 may include one or more modules that facilitate the interaction between the processor 1320 and other components. The processor may be a Central Processing Unit (CPU), a microprocessor, a single chip machine, a Graphical Processing Unit (GPU), or the like.

The memory 1330 is configured to store various types of data to support the operation of the computing environment 1310. The memory 1330 may include predetermined software 1332. Examples of such data includes instructions for any applications or methods operated on the computing environment 1310, video datasets, image data, etc. The memory 1330 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 1340 provides an interface between the processor 1320 and peripheral interface modules, such as a keyboard, a click wheel, buttons, and the like. The buttons may include but are not limited to, a home button, a start scan button, and a stop scan button. The I/O interface 1340 can be coupled with an encoder and decoder.

In an embodiment, there is also provided a method for video decoding, the method may comprise: determining, by a decoder, a search region for a video block from a video frame, wherein the search region has a first search-region dimension in a first direction and a second search-region dimension in a second direction perpendicular to the first direction, wherein the search region comprises a plurality of regions each of which is within an area determined by the first search-region dimension, the second search-region dimension, and a location of the video block in the video frame; determining, by the decoder, a reference block from the search region, wherein a template of the reference block matches a template of the video block; and determining, by the decoder, prediction samples for the video block based on the reference block.

In the method, determining the reference block from the search region comprises: determining a candidate block from one of the plurality of regions; performing an availability check on the candidate block to determine whether samples in the candidate block are reconstructed or not; responsive to there being a sample in the candidate block which is not yet reconstructed, determining the candidate block as an invalid candidate block; or responsive to there being no sample in the candidate block which is not yet reconstructed, determining the candidate block as a valid candidate block.

In the method, the video frame comprises a plurality of coding tree units (CTUs), and the video block is located within one of the CTUs, and the plurality of regions comprise at least one of the following: a first region with a first distance away from the video block in the first direction and with a second distance away from the video block in the second direction; a second region adjacent the first region in the first direction and with the second distance away from the video block in the second direction; a third region adjacent the first region in the second direction and with the first distance away from the video block in the first direction; a fourth region adjacent the second region in the first direction and with the second distance away from the video block in the second direction; a fifth region adjacent the third region in the second direction and with the first distance away from the video block in the first direction; a sixth region adjacent the first region, the third region, and the fifth region in the first direction, wherein a distance between an upper boundary of the sixth region and the video block in the first direction is equal to a product of a height of the video block and a constant, and a distance between the sixth region and the one of the CTUs in the first direction is equal to the height of the video block; a seventh region adjacent the sixth region in the first direction and adjacent the first region and the second region in the second direction, wherein a distance between the seventh region and the one of the CTUs in the second direction is equal to a width of the video block; or an eighth region adjacent the seventh region in the first direction and adjacent the fourth region in the second direction, wherein a distance between the eighth region and the one of the CTUs in the second direction is equal to the width of the video block.

In the method, the availability check is performed for candidate blocks in the fourth and fifth regions; and the availability check is not performed for candidate blocks in the first, second, third, sixth, seventh, and eighth regions, and the candidate blocks in the first, second, third, sixth, seventh, and eighth regions are determined as valid candidate blocks.

In the method, determining the reference block from the search region comprises: determining the reference block to be one of the valid candidate blocks which has a template matching the template of the video block.

In the method, performing the availability check on the candidate block to determine whether the samples in the candidate block are reconstructed or not comprise: determining whether a sample at a bottom-right corner of the candidate block is reconstructed; wherein responsive to the sample at the bottom-right corner being reconstructed, the candidate block is determined as the valid candidate block, or wherein responsive to the sample at the bottom-right corner being not reconstructed, the candidate block is determined as the invalid candidate block.

In an embodiment, there is also provided a method for video encoding, the method may comprise: determining, by a encoder, a search region for a video block from a video frame, wherein the search region has a first search-region dimension in a first direction and a second search-region dimension in a second direction perpendicular to the first direction, wherein the search region comprises a plurality of regions each of which is within an area determined by the first search-region dimension, the second search-region dimension, and a location of the video block in the video frame; determining, by the encoder, a reference block from the search region, wherein a template of the reference block matches a template of the video block; determining, by the encoder, prediction samples for the video block based on the reference block; and generating, by the encoder, a bitstream based on the prediction samples.

In the method, determining the reference block from the search region comprises: determining a candidate block from one of the plurality of regions; performing an availability check on the candidate block to determine whether samples in the candidate block are reconstructed or not; responsive to there being a sample in the candidate block which is not yet reconstructed, determining the candidate block as an invalid candidate block; or responsive to there being no sample in the candidate block which is not yet reconstructed, determining the candidate block as a valid candidate block.

In the method, the video frame comprises a plurality of coding tree units (CTUs), and the video block is located within one of the CTUs, and the plurality of regions comprise at least one of the following: a first region with a first distance away from the video block in the first direction and with a second distance away from the video block in the second direction; a second region adjacent the first region in the first direction and with the second distance away from the video block in the second direction; a third region adjacent the first region in the second direction and with the first distance away from the video block in the first direction; a fourth region adjacent the second region in the first direction and with the second distance away from the video block in the second direction; a fifth region adjacent the third region in the second direction and with the first distance away from the video block in the first direction; a sixth region adjacent the first region, the third region, and the fifth region in the first direction, wherein a distance between an upper boundary of the sixth region and the video block in the first direction is equal to a product of a height of the video block and a constant, and a distance between the sixth region and the one of the CTUs in the first direction is equal to the height of the video block; a seventh region adjacent the sixth region in the first direction and adjacent the first region and the second region in the second direction, wherein a distance between the seventh region and the one of the CTUs in the second direction is equal to a width of the video block; or an eighth region adjacent the seventh region in the first direction and adjacent the fourth region in the second direction, wherein a distance between the eighth region and the one of the CTUs in the second direction is equal to the width of the video block.

In the method, the availability check is performed for candidate blocks in the fourth and fifth regions; and the availability check is not performed for candidate blocks in the first, second, third, sixth, seventh, and eighth regions, and the candidate blocks in the first, second, third, sixth, seventh, and eighth regions are determined as valid candidate blocks.

In the method, determining the reference block from the search region comprises: determining the reference block to be one of the valid candidate blocks which has a template matching the template of the video block.

In the method, performing the availability check on the candidate block to determine whether the samples in the candidate block are reconstructed or not comprise: determining whether a sample at a bottom-right corner of the candidate block is reconstructed, wherein responsive to the sample at the bottom-right corner being reconstructed, the candidate block is determined as the valid candidate block, or wherein responsive to the sample at the bottom-right corner being not reconstructed, the candidate block is determined as the invalid candidate block.

In an embodiment, there is also provided a method for video decoding, the method may comprise: determining, by a decoder, a search region for a video block from a video frame of a video, wherein the search region comprises one or more regions determined based at least in part on a spatial location of template samples of a first template of the video block that are available to the video block; determining, by the decoder, a reference block from the search region, wherein a second template of the reference block matches the first template; and determining, by the decoder, prediction samples for the video block based on the reference block.

In an embodiment, there is also provided a method for video encoding, the method may comprises: determining, by an encoder, a search region for a video block from a video frame of a video, wherein the search region comprises one or more regions determined based at least in part on a spatial location of template samples of a first template of the video block that are available to the video block; determining, by the encoder, a reference block from the search region, wherein a second template of the reference block matches the first template; and determining, by the encoder, prediction samples for the video block based on the reference block.

In an embodiment, there is also provided a non-transitory computer-readable storage medium comprising a plurality of programs, for example, in the memory 1330, executable by the processor 1320 in the computing environment 1310, for performing the above-described methods and/or storing a bitstream generated by the encoding method described above or a bitstream to be decoded by the decoding method described above. In one example, the plurality of programs may be executed by the processor 1320 in the computing environment 1310 to receive (for example, from the video encoder 20 in FIG. 2) a bitstream or data stream including encoded video information (for example, video blocks representing encoded video frames, and/or associated one or more syntax elements, etc.), and may also be executed by the processor 1320 in the computing environment 1310 to perform the decoding method described above according to the received bitstream or data stream. In another example, the plurality of programs may be executed by the processor 1320 in the computing environment 1310 to perform the encoding method described above to encode video information (for example, video blocks representing video frames, and/or associated one or more syntax elements, etc.) into a bitstream or data stream, and may also be executed by the processor 1320 in the computing environment 1310 to transmit the bitstream or data stream (for example, to the video decoder 30 in FIG. 3). Alternatively, the non-transitory computer-readable storage medium may have stored therein a bitstream or a data stream comprising encoded video information (for example, video blocks representing encoded video frames, and/or associated one or more syntax elements etc.) generated by an encoder (for example, the video encoder 20 in FIG. 2) using, for example, the encoding method described above for use by a decoder (for example, the video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

In an embodiment, there is provided a bitstream generated by the encoding method described above or a bitstream to be decoded by the decoding method described above. In an embodiment, there is provided a bitstream comprising encoded video information generated by the encoding method described above or encoded video information to be decoded by the decoding method described above.

In an embodiment, the is also provided a computing device comprising one or more processors (for example, the processor 1320); and the non-transitory computer-readable storage medium or the memory 1330 having stored therein a plurality of programs executable by the one or more processors, wherein the one or more processors, upon execution of the plurality of programs, are configured to perform the above-described methods.

In an embodiment, there is also provided a computer program product having instructions for storage or transmission of a bitstream comprising encoded video information generated by the encoding method described above or encoded video information to be decoded by the decoding method described above. In an embodiment, there is also provided a computer program product comprising a plurality of programs, for example, in the memory 1330, executable by the processor 1320 in the computing environment 1310, for performing the above-described methods. For example, the computer program product may include the non-transitory computer-readable storage medium.

In an embodiment, the computing environment 1310 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

In an embodiment, there is also provided a method of storing a bitstream, comprising storing the bitstream on a digital storage medium, wherein the bitstream comprises encoded video information generated by the encoding method described above or encoded video information to be decoded by the decoding method described above.

In an embodiment, there is also provided a method for transmitting a bitstream generated by the encoder described above. In an embodiment, there is also provided a method for receiving a bitstream to be decoded by the decoder described above.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A method for video decoding, comprising:
determining, by a processor, a search region for a video block from a video frame of a video, wherein the search region comprises a first region a first distance away from the video block in a first direction and a second distance away from the video block in a second direction perpendicular to the first direction, a second region adjacent the first region in the first direction and the second distance away from the video block in the second direction, and a third region adjacent the first region in the second direction and the first distance away from the video block in the first direction;
determining, by the processor, a reference block from the search region, wherein a template of the reference block matches a template of the video block; and
determining, by the processor, prediction samples for the video block based on the reference block.

2. The method of claim 1, wherein:
the first distance in the first direction is equal to a height of the video block in the first direction;
the second distance in the second direction is equal to a width of the video block in the second direction;
a height of the second region is equal to the height of the video block in the first direction; and
a width of the third region is equal to the width of the video block in the second direction.

3. The method of claim 1, wherein the search region further comprises at least one of a fourth region adjacent the second region in the first direction and the second distance away from the video block in the second direction or a fifth region adjacent the third region in the second direction and the first distance away from the video block in the first direction.

4. The method of claim 3, wherein:
the video frame is divided into a plurality of coding tree units (CTUs), and the video block is located within one of the CTUs;
a third distance between the fifth region and a right boundary of the one of the CTUs in the second direction is equal to a width of the video block; and
a fourth distance between the fourth region and a bottom boundary of the one of the CTUs in the first direction is equal to a height of the video block.

5. The method of claim 3, wherein:
the second region and the fourth region have a same width as the first region in the second direction;
the third region and the fifth region have a same height as the first region in the first direction; and
unreconstructed samples are included in the fourth and fifth regions.

6. The method of claim 4, wherein the search region further comprises:
a sixth region adjacent the first region, the third region, and the fifth region in the first direction, wherein a fifth distance between an upper boundary of the sixth region and the video block in the first direction is equal to a product of the height of the video block and a constant, and a sixth distance between the sixth region and the one of the CTUs in the first direction is equal to the height of the video block;
a seventh region adjacent the sixth region in the first direction and adjacent the first region and the second region in the second direction, wherein a height of the seventh region is equal to a sum of a height of the first region and a height of the second region; and
an eighth region adjacent the seventh region in the first direction and adjacent the fourth region in the second direction, wherein a height of the eighth region is equal to a height of the fourth region, and a width of the eighth region is equal to a width of the seventh region.

7. The method of claim 6, wherein the first region, the second region, and the seventh region are merged into a single region.

8. The method of claim 3, wherein determining the reference block from the search region comprises:
determining a plurality of candidate blocks from the search region;
determining a plurality of templates for the plurality of candidate blocks, respectively;
determining, from the plurality of templates, a template that matches the template of the video block; and
determining the reference block to be a first candidate block having the template that matches the template of the video block.

9. The method of claim 8, further comprising:
determining that the plurality of candidate blocks comprise a second candidate block from the fourth region or the fifth region; and
performing an availability check on the second candidate block.

10. The method of claim 9, wherein performing the availability check on the second candidate block comprises:
responsive to determining that the second candidate block includes at least an unreconstructed sample, determining that the second candidate block fails the availability check; or
responsive to determining that the second candidate block includes no unreconstructed samples, determining that the second candidate block passes the availability check.

11. The method of claim 9, wherein performing the availability check on the second candidate block comprises:
responsive to a sample at a bottom-right corner of the second candidate block is unreconstructed, determining that the second candidate block fails the availability check; or
responsive to the sample at the bottom-right corner of the second candidate block is reconstructed, determining that the second candidate block passes the availability check.

12. The method of claim 9, further comprising:
responsive to determining that the second candidate block passes the availability check, keeping the second candidate block in the plurality of candidate blocks; or
responsive to determining that the second candidate block fails the availability check, removing the second candidate block from the plurality of candidate blocks.

13. The method of claim 9, further comprising:
responsive to determining that the second candidate block fails the availability check:
determining unreconstructed samples in the second candidate block; and
updating the second candidate block by generating sample values for the unreconstructed samples.

14. The method of claim 13, wherein the sample values for the unreconstructed samples are generated using at least one of a horizontal repetitive padding method, a vertical repetitive padding method, an adaptive repetitive padding method, or a collocated copying method.

15. The method of claim 1, wherein determining the reference block from the search region comprises:
performing an iterative search method on the search region with at least a scaling factor to identify a first candidate block having the template which matches the template of the video block; and
determining the reference block to be the first candidate block.

16. The method of claim 1, further comprising:
receiving a bitstream including an index of an optimal region; and
identifying the optimal region from the search region based on the index,
wherein determining the reference block from the search region comprises determining the reference block from the optimal region.

17. A method for video encoding, comprising:
determining, by a processor, a search region for a video block from a video frame of a video, wherein the search region comprises a first region a first distance away from the video block in a first direction and a second distance away from the video block in a second direction perpendicular to the first direction, a second region adjacent the first region in the first direction and the second distance away from the video block in the second direction, and a third region adjacent the first region in the second direction and the first distance away from the video block in the first direction;
determining, by the processor, a reference block from the search region, wherein a template of the reference block matches a template of the video block; and
determining, by the processor, prediction samples for the video block based on the reference block.

18. An apparatus for video coding, comprising:
a memory configured to store a bitstream; and
a processor coupled to the memory and configured to perform a method for video decoding, wherein the method comprises:
determining a search region for a video block from a video frame of a video, wherein the search region comprises a first region a first distance away from the video block in a first direction and a second distance away from the video block in a second direction perpendicular to the first direction, a second region adjacent the first region in the first direction and the second distance away from the video block in the second direction, and a third region adjacent the first region in the second direction and the first distance away from the video block in the first direction;
determining a reference block from the search region, wherein a template of the reference block matches a template of the video block; and
determining prediction samples for the video block based on the reference block.

19. A non-transitory computer-readable storage medium having stored therein a bitstream to be decoded by the method for video decoding according to claim 1.

20. A method for storing a bitstream, comprising:
performing the method for video encoding according to claim 17 to generate a bitstream; and
storing the bitstream.
